(19) United States
(12) Patent Application Publication
(10) Pub. No.: US 2025/0209826 A1
(43) Pub. Date: Jun. 26, 2025

(54) DETECTING THE SURROUNDINGS OF AND TELE-OPERATED GUIDANCE OF AN EGO VEHICLE

(71) Applicant: VALEO SCHALTER UND SENSOREN GMBH, Bietigheim-Bissingen (DE)

(72) Inventors: Michael Fischer, Kronach Neueses (DE); David Kudlek, Kronach Neueses (DE); David Middrup, Kronach Neueses (DE); Eugen Wige, Kronach Neueses (DE)

(73) Assignee: VALEO SCHALTER UND SENSOREN GMBH, Bietigheim-Bissingen (DE)

(21) Appl. No.: 18/852,309

(22) PCT Filed: Mar. 23, 2023
(86) PCT No.: PCT/EP2023/057402

§ 371 Date: Sep. 27, 2024

(30) Foreign Application Priority Data
Mar. 28, 2022 (DE) 10 2022 107 250.9

(51) Int. Cl. G06V 20/58; G05D 1/224; G05D 101/00; G06V 10/10; G06V 10/26; G06V 10/75

(52) U.S. Cl. CPC G06V 20/58; G05D 1/2248; G06V 10/16; G06V 10/26; G06V 10/751; G05D 2101/22

(57) ABSTRACT

According to a method for detecting surroundings, a first image data stream (15) is generated by means of a first camera (2) of an ego vehicle (4) and a second image data stream, which is generated by means of a second camera of a further vehicle (5), is received by means of the ego vehicle (4), wherein a first visual field (8) represented by the first image data stream (15) overlaps with a second visual field (9) represented by the second image data stream. A region (14) which is obscured for the first camera (2) is identified in the first visual field (8), which region is not obscured for the second camera. On the basis of the second image data stream, substitute image data (17) is generated which corresponds to the region (14) that is obscured for the first camera (2). On the basis of the first image data stream (15), a combined image data stream is generated which represents the first visual field, wherein the substitute image data (17) is displayed in a region (14) of the combined image data stream (16), which corresponds to the region (14) obscured for the first camera (2).

The invention relates to a method for detecting the surroundings, wherein a first image data stream is generated by means of a first camera of an ego vehicle, and to a method for tele-operated guidance of an ego vehicle. The invention further relates to a corresponding surroundings detection system, a vehicle guidance system for tele-operated guidance of an ego vehicle, and a computer program product.

In the operation of highly automated vehicles, in particular fully autonomous vehicles, if a situation arises which the vehicle can no longer handle independently or handle independently with sufficient safety, so-called tele-operated guidance can be used. In this case, a human tele-operator gains access via a vehicle-external computer system to the data acquired by means of various sensor systems, in particular cameras, of the vehicle from the surroundings of the vehicle and can then control the vehicle remotely in order to resolve the situation.

In some situations, however, the visual field of a camera on the vehicle is partially obscured, for example by another vehicle traveling in front of it. In that event, the tele-operator may not be able to take into account relevant but obscured information for the remote control, which can pose a safety risk.

An object of the present invention is to improve safety during tele-operated guidance of a vehicle.

This object is achieved by the respective subject matter of the independent claims. Advantageous refinements and preferred embodiments are the subject matter of the dependent claims.

The invention is based on the idea of overcoming restrictions in the visual field of the camera of the vehicle to be guided, which are caused by obscuring objects such as other vehicles driving ahead, by combining an image data stream of a camera of a further vehicle with the image data stream of the vehicle to be guided. In particular, substitute image data from the image data stream of the further vehicle is displayed in an obscured region of the image data stream of the vehicle to be guided.

According to one aspect of the invention, a method for detecting the surroundings is specified, wherein a first image data stream is generated by means of a first camera of an ego vehicle. A second image data stream generated by means of a second camera of a further vehicle is received, in particular by means of at least one computing unit. A first visual field represented by the first image data stream overlaps with a second visual field represented by the second image data stream. On the basis of the first image data stream and the second image data stream, a region which is obscured for the first camera is identified in the first visual field, which region is not obscured for the second camera, in particular by means of a computing unit. On the basis of the second image data stream, substitute image data is generated that corresponds to the region which is obscured for the first camera, in particular by means of the at least one computing unit. On the basis of the first image data stream, and in particular the second image data stream, a combined image data stream is generated that represents the first visual field. The substitute image data is displayed in a region of the combined image data stream corresponding to the region that is obscured for the first camera.

The second image data stream is received in particular by means of the at least one computing unit, for example by means of at least one vehicle computing unit of the ego vehicle, in particular via a first communication interface for wireless communication, for example V2V or V2X communication. V2V stands for vehicle-to-vehicle and V2X stands for vehicle-to-anything.

The at least one computing unit contains, for example, the at least one vehicle computing unit and can include, for example, a vehicle-external computer system, that is, a computer system arranged externally to the ego vehicle and the further vehicle. The vehicle-external computer system can be referred to as a server computer system or backend computer system, for example. In particular, it may be a computer system for the tele-operated guidance of vehicles, in particular the ego vehicle.

The second image data stream is generated in particular by means of the second camera and transmitted from the further vehicle, for example, from a further vehicle computing unit of the further vehicle, in particular via a further communication interface for wireless communication, for example for V2V or V2X communication, to the ego vehicle, in particular the at least one computing unit, for example, the at least one vehicle computing unit, in particular via the first communication interface.

For example, an image data stream can mean a sequence of two or more consecutive images. The first image data stream, in particular corresponding first images of the first image data stream, represent in particular external surroundings of the ego-vehicle. The first visual field, which can also be understood as the visual field of the first camera, is thus located at least partly in the external surroundings of the ego vehicle. The second image data stream, in particular corresponding second images of the first image data stream, represent in particular external surroundings of the further vehicle. The second visual field, which can also be understood as the visual field of the second camera, is thus located at least partly in the external surroundings of the further vehicle.

Since the first visual field and the second visual field overlap, the first and second image data streams generally represent partially matching content. However, since the region that is obscured for the first camera is not obscured for the second camera, the second image data stream represents content that the first image stream does not represent due to the first camera being obscured. For example, the concealment can be due to an obscuring object in the first visual field. The obscuring object may be, for example, but not necessarily, the further vehicle itself.

The substitute image data can therefore be generated, for example, based on the image data of the second image data stream, which represents a region of the second visual field which is also located in the first visual field and would be represented by that of the first image data stream if the concealing object were not present. The corresponding image data of the second image data stream can in particular be processed or modified to generate the substitute image data, in particular to adapt the representation to the first image data stream.

The combined image data stream corresponds in particular to a combination of the first image data stream or to an edited variant of the first image data stream with the substitute image data.

Outside the region corresponding to the region that is obscured for the first camera, for example, the combined image data stream may be identical to the first image data stream. In the region corresponding to the region that is obscured for the first camera, the combined image data stream can correspond, for example, to the substitute image data or to a superposition of the substitute image data with the first image data stream. There may also be a transitional region between these regions.

Due to the substitute image data therefore, the combined image data stream contains information that would otherwise not be available to the ego vehicle due to the concealment. An observer of the combined image data stream, such as a tele-operator, who is remotely controlling the ego vehicle by tele-operated guidance, can therefore be informed more extensively by the ego vehicle about the current conditions in the surroundings of the ego vehicle, which ultimately increases safety when the ego vehicle is operated by tele-operated guidance.

According to at least one embodiment of the method according to the invention for detecting the surroundings, a deviation of one or more extrinsic camera parameters and/or one or more intrinsic camera parameters between the first camera and the second camera is at least partially compensated, for example by means of the at least one computing unit, by transforming the second image data stream according to a, for example pre-defined, transformation parameter set. The region obscured for the first camera is identified based on the first image data stream and the transformed second image data stream, in particular by means of the at least one computing unit, for example by means of the at least one vehicle computing unit.

Extrinsic camera parameters include, for example, a pose, i.e. a position and orientation, of a camera coordinate system of the corresponding camera with respect to a reference coordinate system. The camera coordinate system is rigidly connected to the respective camera. For example, the reference coordinate system can be rigidly connected to the respective vehicle or to the surroundings of the respective vehicle. A common reference coordinate system can also be selected for cameras of different vehicles. For example, the pose can be defined by six parameters, such as three position parameters and three orientation parameters. The three position parameters can be, for example, three-dimensional coordinates of a coordinate origin of the camera coordinate system in the reference coordinate system. For example, the three orientation parameters can be three orientation angles, such as Euler angles, which can also be referred to as pitch, yaw and roll angles.

The intrinsic camera parameters may include parameters that define how a point in the vicinity of the camera is imaged by the camera, in particular on an image sensor of the camera. Thus, the intrinsic camera parameters can describe or define, for example, an imaging function of a lens of the camera, a focal length, and so on. The intrinsic camera parameters may also include an aspect ratio, a resolution, and/or pixel density of the image sensor. The intrinsic camera parameters may also relate to a camera-internal preprocessing of the acquired image data, for example, parameters relating to white balance, image sharpening, color correction or the like.

According to at least one embodiment, the combined image data stream is generated on the basis of the first image data stream and the transformed second image data stream, wherein the substitute image data is generated based on the transformed second image data stream, in particular by means of the at least one computing unit, for example by means of the at least one vehicle computing unit.

The at least partial compensation of the deviation of the extrinsic and/or one of the intrinsic camera parameters allows, for example, deviations between the first image data stream and the second image data stream in a scale and/or a scaling of imaged objects to be at least partially compensated, an offset and/or displacement of the first visual field with respect to the second visual field to be at least partially compensated and/or perspective deviation between the first image data stream and the second image data stream to be at least partially compensated. This ensures that the substitute image data in combination with the image data from the first image data stream permit a consistent representation of the surroundings, which in the application case of tele-operated guidance of the ego vehicle ultimately increases safety.

According to at least one embodiment, in particular based on the first image data stream and the second image data stream, at least one feature is identified, which is represented by both the first image data stream and by the second image data stream, in particular by means of the at least one computing unit, for example by means of the at least one vehicle computing unit. The transformation parameter set is determined depending on a comparison of a representation of the at least one feature in the first image data stream with a representation of the at least one feature in the second image data stream, in particular by means of the at least one computing unit, for example by means of the at least one vehicle computing unit.

By identifying and comparing the given feature, the effects of the deviation of one or more extrinsic camera parameters and/or one or more intrinsic camera parameters between the first camera and the second camera can be directly extracted from the image data streams. Deviations of the camera parameters that may not have a relevant effect are therefore advantageously not explicitly taken into account and therefore do not need to be explicitly determined. This makes compensating for the deviation in the camera parameters more efficient.

According to at least one embodiment, a tonal value distribution and/or a color value distribution of the second image data stream is compared against a tonal value distribution and/or a color value distribution of the first image data stream, in particular by means of the at least one computing unit, for example by means of the at least one vehicle computing unit. Based on a result of the comparison, the transformed second image data stream is corrected or the second image data stream is corrected before the transformation. The substitute image data is generated based on the transformed and corrected second image data stream.

In particular, this ensures that the brightness and the white balance in the combined image data stream are consistent, which ultimately further increases safety in the application case of tele-operated guidance of the ego vehicle.

The tonal value distribution and/or a color value distribution can be given, for example, by one or more corresponding histograms.

According to at least one embodiment, the substitute image data is superimposed on the first image data stream, in particular on the region of the first image data stream which corresponds to the region that is obscured for the first camera, in order to generate the combined image data stream.

For example, the substitute image data is superimposed in a partially transparent manner on original image data of the first image data stream which corresponds to the region that is obscured for the first camera in the first image data stream.

In the combined image data stream, both the substitute image data and the original image data are thereby represented. The combined image data stream thus represents both the obscuring object and also the content located behind the obscuring object when viewed from the first camera. The viewer, for example the tele-operator, can therefore take more information into account when making decisions, which ultimately further increases safety in the application of tele-operated guidance of the ego vehicle.

According to at least one embodiment, the further vehicle is located in the first visual field, in particular, the further vehicle is represented by the first image data stream, and the region that is obscured for the first camera is concealed for the first camera by the further vehicle. In other words, the further vehicle is the obscuring object.

For example, the further vehicle may be driving in from of the ego vehicle on a road, in particular in the same lane on which the ego vehicle is located or in another, for example, adjacent lane. For example, the first camera may be a forward-facing camera of the ego vehicle, also known as a front camera. The second camera may be, for example, a front camera of the further vehicle.

According to at least one embodiment, the region that is obscured for the first camera is identified by means of at least one vehicle computing unit of the ego vehicle.

Alternatively, the at least one vehicle computing unit can transmit the first image data stream and the second image data stream, in particular via the first communication interface or a second communication interface, to the external computer system and the external computer system can identify the region obscured for the first camera.

According to at least one embodiment, the substitute image data is determined by means of the at least one vehicle computing unit of the ego vehicle.

Alternatively, the at least one vehicle computing unit can transmit the second image data stream and optionally the first image data stream, in particular via the first communication interface or the second communication interface, to the external computer system and the external computer system can determine the substitute image data.

According to at least one embodiment, the combined image data stream is generated by means of the at least one vehicle computing unit of the ego vehicle.

Alternatively, the at least one vehicle computing unit can transmit the first image data stream to the external computer system, in particular via the first communication interface or a second communication interface. The at least one vehicle computing unit can thus also transmit the second image data stream or the substitute image data to the external computer system. The external computer system can then generate the combined image data stream.

In a preferred embodiment, the steps of identifying the obscured region, generating the substitute image data and generating the combined image data stream are carried out by the at least one vehicle computing unit. For example, the combined image data stream is transmitted by means of the at least one vehicle computing unit, in particular via the first communication interface or the second communication interface, to the external computer system.

According to at least one embodiment, the combined image data stream is displayed by means of the vehicle-external computer system on a vehicle-external display device, such as one or more screens or monitors, or a visual output device to be worn on the head, also known as an HMD (“head mounted display”). Beforehand, the combined image data stream is generated, for example, by means of the at least one vehicle computing unit and transmitted, in particular via the first communication interface or the second communication interface, to the external computer system or the combined image data stream is generated by means of the external computer system.

According to a further aspect of the invention, a method for tele-operated guidance of an ego vehicle is specified. For this purpose, a method according to the invention for detecting surroundings is carried out, in particular the combined image data stream being displayed on the vehicle-external display device by means of the vehicle-external computer system. In response to the display of the combined image data stream on the vehicle-external display device, in particular after the display or simultaneously with the display, a user input, in particular of the tele-operator, is captured by means of the vehicle-external computer system. The ego vehicle is guided, in particular remotely controlled, at least partially automatically depending on the user input.

According to at least one embodiment of the method for tele-operated guidance of the ego vehicle, the vehicle-external computer system is used to generate a control command depending on the user input and transmit it to the ego vehicle. The ego vehicle is guided at least partially automatically depending on the control command, in particular by means of an ego-vehicle guidance system of the ego vehicle.

Here, the ego vehicle guidance system can be understood in particular as an electronic system which is configured to guide the ego vehicle fully automatically or fully autonomously, in particular without control intervention by a driver being necessary. The ego vehicle performs all necessary functions, such as steering, braking and/or acceleration maneuvers, the observation and detection of road traffic and appropriate reactions, automatically. In particular, the ego vehicle guidance system can implement a fully automatic or fully autonomous driving mode of the motor vehicle according to Level 5 of the classification according to SAE J3016. In particular, the ego vehicle guidance system may implement a fully automatic or fully autonomous driving mode of the motor vehicle according to Level 4 of the classification according to SAE J3016. Here and hereinbelow, “SAE J3016” refers to the corresponding standard in the version of June 2018.

The ego vehicle guidance system can generate one or more control signals, for example depending on the control command, and transmit them to one or more actuators of the ego vehicle so that they influence or carry out a transverse and/or longitudinal control of the ego vehicle according to the control command.

According to a further aspect of the invention, a surroundings detection system is specified, which comprises a first camera for an ego vehicle, which is configured to generate a first image data stream. The surroundings detection system has at least one communication interface for the ego vehicle for wireless data transmission, and at least one computing unit, in particular at least one vehicle computing unit. The at least one computing unit, in particular the at least one vehicle computing unit, is configured to receive a second image data stream which is generated by means of a second camera of a further vehicle via the at least one communication interface, for example the fist communication interface, wherein a first visual field represented by the first image data stream overlaps with a second visual field represented by the second image data stream. The at least one computing unit, in particular the at least one vehicle computing unit, is configured to identify, on the basis of the first image data stream and the second image data stream, an obscured region for the first camera in the first visual field, which region is not obscured for the second camera, and to generate, based on the second image data stream, substitute image data corresponding to the region obscured for the first camera. The at least one computing unit, in particular the at least one vehicle computing unit, is configured to generate, based on the first image data stream and in particular on the second image data stream, a combined image data stream which represents the first visual field, and to display the substitute image data in a region of the combined image data stream corresponding to the region that is obscured for the first camera.

According to at least one embodiment of the surroundings detection system, the surroundings detection system is designed as an ego vehicle guidance system for the ego vehicle.

According to at least one embodiment of the surroundings detection system, this comprises a vehicle-external display device and the at least one computing unit contains a vehicle-external computer system.

In such embodiments, the surroundings detection system may also be referred to as a vehicle guidance system for the tele-operated guidance of the ego vehicle.

According to at least one embodiment of the surroundings detection system, the vehicle-external computer system is configured to generate the combined image data stream and display it on the vehicle-external display device. In this case, the vehicle-external computer system can, for example, receive the first image data stream and the second image data stream from the at least one vehicle computing unit.

According to at least one embodiment of the surroundings detection system, the at least one vehicle computing unit is configured to receive the second image data stream via the at least one communication interface, in particular the first communication interface, to identify the region obscured for the first camera, to generate the substitute image data, to generate the combined image data stream and transmit the combined image data stream via the at least one communication interface, in particular the first communication interface or the second communication interface, to the vehicle-external computer system. The vehicle-external computer system is configured to display the combined image data stream on the vehicle-external display device.

According to at least one embodiment of the vehicle guidance system, for the tele-operated guidance of the ego vehicle the vehicle-external computer system is configured to detect a user input in response to the display of the combined image data stream on the vehicle-external display device. For the tele-operated guidance the vehicle guidance system has an ego vehicle guidance system for the ego vehicle, which is configured to guide the ego vehicle at least partially automatically depending on the user input.

According to at least one embodiment of the vehicle guidance system, for the tele-operated guidance of the ego vehicle the vehicle-external computer system is configured to generate a control command depending on the user input and transmit it to the ego vehicle. The ego vehicle guidance system is configured to guide the ego vehicle at least partially automatically depending on the control command.

Further embodiments of the surroundings detection system according to the invention and of the vehicle guidance system according to the invention follow directly from the various configurations of the method according to the invention for detecting the surroundings and of the method according to the invention for tele-operated guidance of an ego vehicle, and vice versa in each case. In particular, individual features and corresponding explanations with regard to the various embodiments of the inventive methods can be transferred analogously to corresponding embodiments of the surroundings detection system according to the invention and the vehicle guidance system according to the invention. In particular, the surroundings detection system according to the invention is designed or programmed to carry out a method according to the invention for detecting the surroundings. In particular, the surroundings detection system according to the invention carries out the method according to the invention for detecting the surroundings. In particular, the vehicle guidance system according to the invention is designed or programmed to carry out a method according to the invention for tele-operated guidance of an ego vehicle. In particular, the vehicle guidance system according to the invention carries out the method according to the invention for tele-operated guidance of an ego vehicle.

According to a further aspect of the invention, a first computer program having first instructions is specified. When the first instructions are carried out by a surroundings detection system according to the invention, the first instructions prompt the surroundings detection system to carry out a method according to the invention for detecting the surroundings.

According to a further aspect of the invention, a second computer program having second instructions is specified. When the second instructions are carried out by a vehicle guidance system according to the invention for tele-operated guidance of an ego vehicle, the second instructions prompt the vehicle guidance system to carry out a method according to the invention for tele-operated guidance of an ego vehicle.

According to a further aspect of the invention, a computer-readable storage medium is specified, which stores a first computer program according to the invention and/or a second computer program according to the invention.

The first computer program, the second computer program, and the computer-readable storage medium can each be regarded as respective computer program products having the first and/or the second instructions.

The term computing unit can be understood to mean, in particular, a data processing device which contains a processing circuit. The computing unit can therefore process data in particular for carrying out computing operations. Optionally, these also include operations for performing indicated accesses to a data structure, for example a lookup table (LUT).

In particular, the computing unit may contain one or more computers, one or more microcontrollers and/or one or more integrated circuits, for example one or more application-specific integrated circuits (ASICs), one or more field-programmable gate arrays (FPGAs) and/or one or more systems on a chip (SoCs). The computing unit may also contain one or more processors, for example one or more microprocessors, one or more central processing units (CPUs), one or more graphics processing units (GPUs) and/or one or more signal processors, in particular one or more digital signal processors (DSPs). The computing unit may also contain a physical or virtual group of computers or other types of the mentioned units.

In various exemplary embodiments, the computing unit contains one or more hardware and/or software interfaces and/or one or more storage units.

A storage unit can be embodied as a volatile data memory, for example, as a dynamic random access memory (DRAM) or a static random access memory (SRAM), or as a non-volatile data memory, for example as a read-only memory (ROM), as a programmable read-only memory (PROM), as an erasable read-only memory (EPROM), as an electrically erasable read-only memory (EEPROM), as a flash memory or flash EEPROM, as a ferroelectric random-access memory (FRAM), as a magnetoresistive random-access memory (MRAM), or as a phase-change random-access memory (PCRAM).

If reference is made within the scope of the present disclosure to a component of the surroundings detection system or vehicle guidance system according to the invention, in particular the at least one computing unit, the at least one vehicle computing unit and/or the vehicle-external computer system, being configured, embodied, designed, or the like to carry out or implement a specific function, to achieve a specific effect or to serve a specific purpose, this can be understood as meaning that the component is specifically and actually able to carry out or implement the function, to achieve the effect or to serve the purpose, beyond the fundamental or theoretical usability or suitability of the component for this function, effect or purpose, by way of an appropriate adaptation, appropriate programming, an appropriate physical design and so on.

Further features of the invention can be found in the claims, the figures, and the description of the figures. The features and combinations of features mentioned above in the description and the features and combinations of features mentioned below in the description of the figures and/or shown in the figures can be included in the invention not only in the combination specified in each case, but also in other combinations. In particular, embodiments and combinations of features that do not have all the features of an originally worded claim can also be included in the invention. Furthermore, embodiments and combinations of features that go beyond or differ from the combinations of features set out in the back-references of the claims can be included in the invention.

The invention is explained in more detail below on the basis of specific exemplary embodiments with reference to associated schematic drawings. In the figures, identical or functionally identical elements may be provided with the same reference signs. The description of identical or functionally identical elements may not necessarily be repeated with respect to different figures.

In the figures:

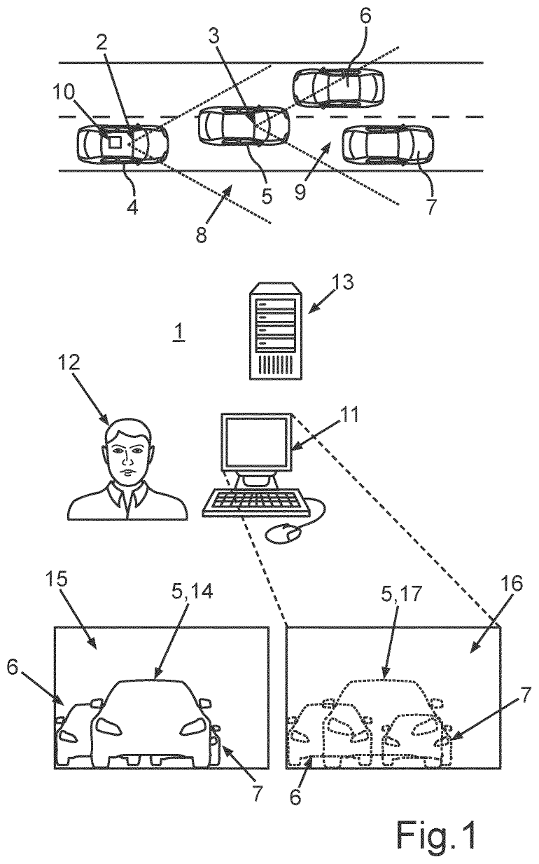

FIG. 1 shows a schematic illustration of an exemplary embodiment of a surroundings detection system according to the invention; and

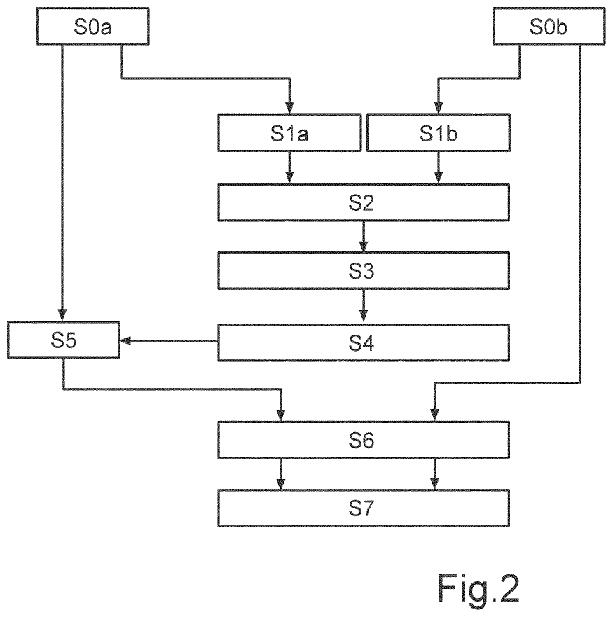

FIG. 2 shows a schematic flowchart of an exemplary embodiment of a method according to the invention for detecting the surroundings.

In FIG. 1, an exemplary embodiment of a surroundings detection system 1 according to the invention is schematically illustrated, which in particular also shows a vehicle guidance system according to the invention for the tele-operated guidance of an ego vehicle 4.

The ego vehicle 4 is driving on a road behind a further vehicle 5. For example, further vehicles 6, 7 may be driving in front of the further vehicle 5.

The surroundings detection system 1 has a first camera 2, in particular front camera, of the ego vehicle 4, which is configured to generate a first image data stream 15, which represents a first visual field 8 of the first camera 2. The further vehicle 5 and, for example, the further vehicles 6, 7 are located in the first visual field 8, wherein the further vehicle 5 obscures, for example, a region 14 in the first visual field 8 for the first camera 2, so that in particular the further vehicles 6, 7 are partially obscured in the first image data stream 15.

The further vehicle 5 has a second camera 3, in particular front camera, which is configured to generate a second image data stream, which represents a second visual field 9 of the second camera 3. The further vehicles 6, 7 are located, for example, in the second visual field 9 and in this case are in particular not obscured for the second camera 3, or less obscured than for the first camera 2.

The ego vehicle 4 and the further vehicle 5 each have a communication interface for wireless data transmission, for example a V2V or V2X interface. In addition, the surroundings detection system 1 has a vehicle computing unit 10 and a vehicle-external computer system 10, which is, for example, part of a backend for tele-operated guidance of vehicles.

The vehicle computing unit 10 receives the second image data stream from the further vehicle 5, for example from a further vehicle control unit of the further vehicle 5, via the communication interfaces.

The vehicle computing unit 10 identifies, for example, based on a comparison of the first image data stream 15 against the second image data stream, the region 14 that is obscured for the first camera 2 and generates substitute image data 17 corresponding to the region 14 obscured for the first camera 2, based on the second image data stream.

Then, the vehicle computing unit 10 generates a combined image data stream 16 which represents the first visual field 8, wherein the substitute image data 17 is displayed in a region of the combined image data stream 16, which corresponds to the region 14 obscured for the first camera 2, for example superimposed on the original image data of a first image data stream 15 in a semi-transparent manner.

The vehicle computing unit 10 can transmit the combined image data stream 16 wirelessly to the vehicle-external computer system 13. The surroundings detection system 1, in particular the backend, has a vehicle-external display device 11. The vehicle-external computer system 13 is configured to generate the combined image data stream 16 and to display it on the vehicle-external display device 11.

A tele-operator 12 can analyze the displayed combined image data stream 16 and, in response to it, perform a user input on an input device of the vehicle-external computer system 13. Depending on the user input, the vehicle-external computer system 13 can transmit a control command to the vehicle computing unit 10. Based on the control command, the ego vehicle 4 can then be guided at least partially automatically.

FIG. 2 shows a schematic flowchart of an exemplary embodiment of a method according to the invention for detecting the surroundings.

In step S0a, the further vehicle 5 is identified and selected, for example, on the basis of V2V or V2X capabilities of the further vehicle 5 and/or the relative position with respect to the ego vehicle 4. In addition, the second image data stream is generated and transmitted to the ego vehicle 4. In step S0b, the first image data stream is generated.

In step S1a, features are identified in the second image data stream and in step S1b, features are identified in the first image data stream 15. In step S2, matching features from the first image data stream 15 and the second image data stream are then identified based on the previously identified features. The features can be, for example, objects or edges or the like in the respective image data stream. In step S3, the matching features are compared and in step S4, on the basis of the comparison a transformation parameter set is determined, which transforms the matching features of the second image data stream approximately into the matching features of the first image data stream 15. In particular, the transformation parameters of the transformation parameter set are optimized to achieve an optimal superposition of the matching features. The transformation parameter set relates in particular to a scale, displacements and/or perspective adjustments.

Since the first camera 2 and the second camera 3 do not necessarily have the same white balance, brightness and contrast, the color of the second image data stream can optionally also be adjusted. This can be achieved, for example, by adjusting the histograms of the first image data stream 15 and the second image data stream. In step S6, the obscured region 14 is masked. To do this, the relevant regions are identified by comparing the two image data streams and detecting significantly different regions. These regions are highly likely to be obscured by the further vehicle 5. Alternatively, the location data of the vehicle traveling in front can be used, if available. In step S7, the combined image data stream 16 is generated.

In known tele-operated vehicles, the view of the tele-operator is limited to the camera images of the vehicle to be guided. In the absence of direct feedback from the vehicle and the surroundings, it is desirable to assist the tele-operator as much as possible.

The invention makes it possible, in various embodiments, to reduce the visual restriction of the tele-operator due to obscuring objects by using camera data of other road users.

In various embodiments of the invention, V2X communication technologies are used, which allow communication between individual vehicles and permanently installed units for the exchange of sensor data.

1. A method for detecting surroundings, wherein a first image data stream is generated by a first camera of an ego vehicle, the method comprising:
receiving a second image data stream, which is generated by a second camera of a further vehicle, wherein a first visual field represented by the first image data stream overlaps with a second visual field represented by the second image data stream;
on the basis of the first image data stream and the second image data stream, identifying a region which is obscured for the first camera in the first visual field, wherein the region is not obscured for the second camera;
on the basis of the second image data stream, generating substitute image data which corresponds to the region that is obscured for the first camera; and
on the basis of the first image data stream, generating a combined image data stream which represents the first visual field, wherein the substitute image data is displayed in a region of the combined image data stream, which corresponds to the region obscured for the first camera.

2. The method as claimed in claim 1, wherein
a deviation of one or more extrinsic camera parameters and/or one or more intrinsic camera parameters between the first camera and the second camera is at least partially compensated by transforming the second image data stream according to a transformation parameter set; and
the region obscured for the first camera is identified on the basis of the first image data stream and the transformed second image data stream.

3. The method as claimed in claim 2, wherein the combined image data stream is generated on the basis of the first image data stream and the transformed second image data stream, wherein the substitute image data is generated on the basis of the transformed second image data stream.

4. The method as claimed in claim 2, wherein
at least one feature is identified, which is represented by both the first image data stream and the second image data stream; and
the transformation parameter set is determined depending on a comparison of a representation of the at least one feature in the first image data stream with a representation of the at least one feature in the second image data stream.

5. The method as claimed in any of-the-preceding claim 1, wherein the substitute image data is superimposed on the first image data stream in order to generate the combined image data stream.

6. The method as claimed in claim 5, wherein the substitute image data is superimposed in a partially transparent manner on original image data of the first image data stream which corresponds to the region obscured for the first camera in the first image data stream.

7. The method as claimed in claim 1, wherein the further vehicle is located in the first visual field and the region obscured for the first camera is obscured by the further vehicle for the first camera.

8. The method as claimed in claim 1, wherein
the region obscured for the first camera is identified by at least one vehicle computing unit of the ego vehicle; and/or
the substitute image data is determined by the at least one vehicle computing unit of the ego vehicle; and/or
the combined image data stream is generated by the at least one vehicle computing unit of the ego vehicle.

9. The method as claimed in claim 1, wherein the combined image data stream is displayed on a vehicle-external display device by means of a vehicle-external computer system.

10. A method for tele-operated guidance of an ego vehicle, comprising:
carrying out a method for detecting surroundings as claimed in claim 9;
in response to the display of the combined image data stream on the vehicle-external display device, capturing a user input by the vehicle-external computer system; and
controlling the ego vehicle at least partially automatically depending on the user input.

11. The method as claimed in claim 10, wherein
the vehicle-external computer system is used to transmit a control command to the ego vehicle, depending on the user input; and
the ego vehicle is guided at least partially automatically depending on the control command.

12. A surroundings detection system, comprising:
a first camera for an ego vehicle, which is configured to generate a first image data stream,
at least one communication interface for the ego vehicle for wireless data transmission; and
at least one computing unit, wherein the at least one computing unit is configured to:
receive a second image data stream which is generated by means of a second camera of a further vehicle via the at least one communication interface, wherein a first visual field represented by the first image data stream overlaps with a second visual field represented by the second image data stream;
on the basis of the first image data stream and the second image data stream, identify a region which is obscured for the first camera in the first visual field, which region is not obscured for the second camera;
on the basis of the second image data stream, generate substitute image data which corresponds to the region that is obscured for the first camera; and
on the basis of the first image data stream, generate a combined image data stream which represents the first visual field, and at the same time to display the substitute image data in a region of the combined image data stream, which corresponds to the region obscured for the first camera.

13. The surroundings detection system as claimed in claim 12, wherein the surroundings detection system comprises a vehicle-external display device and the at least one computing unit contains a vehicle-external computer system, and
the vehicle-external computer system is configured to generate the combined image data stream and to display it on the vehicle-external display device; or
the at least one computing unit contains at least one vehicle computing unit, which is configured to receive the second image data stream via the at least one communication interface, to identify the region obscured for the first camera, to generate the substitute image data, to generate the combined image data stream and to transmit the combined image data stream via the at least one communication interface to the vehicle-external computer system and the vehicle-external computer system is configured to display the combined image data stream on the vehicle-external display device.

14. A vehicle guidance system for tele-operated guidance of an ego vehicle, wherein
the vehicle guidance system has a surroundings detection system as claimed in claim 13;
the vehicle-external computer system is configured to capture user input in response to the display of the combined image data stream on the vehicle-external display device; and
the vehicle guidance system has an ego vehicle guidance system for the ego vehicle, which is configured to guide the ego vehicle at least partially automatically depending on the user input.

15. (canceled)
